(19) United States
(12) Patent Application Publication
(10) Pub. No.: US 2012/0243724 A1
(43) Pub. Date: Sep. 27, 2012

(54) EAR PAD AND EARPHONE HAVING THE SAME

(75) Inventors: Kanemori Takai, Shinagawa (JP); Atsuhito Horino, Ebina (JP); Tomonari Kaneko, Ebina (JP); Masahiro Yamaguchi, Shinagawa (JP)

(73) Assignees: MOLEX INCORPORATED, LISLE, IL (US); FINAL AUDIO DESIGN OFFICE INC, AICHI (JP); S'NEXT CO., LTD., TOKYO (JP)

(21) Appl. No.: 13/392,732

(22) PCT Filed: Aug. 25, 2010
(86) PCT No.: PCT/US10/46679

§ 371 Date: Jun. 13, 2012

(30) Foreign Application Priority Data
Aug. 25, 2009 (JP) 2009-194328
Aug. 25, 2009 (JP) 2009-194633
Aug. 25, 2009 (JP) 2009-194644

(51) Int. Cl. H04R 1/10

(52) U.S. Cl. 381/380

(57) ABSTRACT

An ear pad is made of a deformable material and mounted on an earphone, at least a tip of which is insertable into an ear. The ear pad comprises a cylindrical body portion and an elastically deformable portion. The cylindrical body portion has a sound guide hole formed therein, being adapted to cause a sound to impinge on the ear. The deformable portion is connected to a tip of the body portion and spreads from the tip toward a rear end of the body portion, and includes a plurality of slit-shaped openings radially extending therefrom. The body portion includes grooves axially extending therefrom, corresponding to the openings in the outer peripheral surface of the body portion. Each opening overlaps with a corresponding groove in cases where the elastically deformable portion is deformed and pressed against the outer peripheral surface of the body portion.

### REFERENCE TO RELATED APPLICATIONS

The Present application claims priority to prior-filed Japanese Patent Application Nos. 2009-194328, entitled “Ear Pad And Earphone Having The Same;” 2009-194633, entitled “Earphone;” and 2009-194644, entitled “Earphone.” Each of these aforementioned Applications was filed with the Japanese Patent Office on 25 Aug. 2009. Further, the contents of each of these aforementioned Applications are fully incorporated herein in their entireties.

### BACKGROUND OF THE PRESENT APPLICATION

The Present Application relates, generally, to an ear pad, and, more particularly, to an ear pad, at least a part of which is inserted into an external auditory meatus, and an earphone having such an ear pad.

Conventional earphones, in which an ear pad made of an elastic material, such as soft rubber, are typically mounted on a portion inserted into an external auditory meatus from the recess of the auricle. An example of such a conventional earphone is disclosed in Japanese Utility Model Registration No. 3121893. This type of earphone is generally attached by inserting the ear pad into the external auditory meatus (that is, the inner ear) from the recess of the auricle (that is, the outer ear), and therefore is able to be securely attached to the auricle. Moreover, the ear pad is made of an elastic material, and therefore is easily deformable to fit the shape of the external auditory meatus, thereby providing comfort in wear.

FIG. 6 illustrates a partial cross-section, illustrating the structure of a conventional earphone. In FIG. 6, housing 811 of the earphone is equipped with a driver unit, not shown, having a diaphragm and the like inside. Further, the lower end of housing 811 is connected to one end of electric wire cable 891, whose other end is connected to audio equipment, also not shown. Moreover, the right end of housing 811 is integrally connected to the base end of sound guide tube 815, which extends rightward. In sound guide tube 815, sound guide hole 816 is formed so as to be in communication with a space inside housing 811. Further, base portion 851 of ear pad 850, made of an elastic material, is fit around sound guide tube 815. Ear pad 850 includes guide tube portion 852, which extends rightward from base portion 851, and thin cap portion 855, which spreads from the tip of guide tube portion 852 toward the periphery thereof, with guide tube portion 852 having guide hole portion 853 formed therein, which is in communication with sound guide hole 816 and opens into the center of cap portion 855. Moreover, small holes 856 are formed in cap portion 855.

When wearing the conventional earphone, the tip portion of ear pad 850 is inserted into the external auditory meatus. In doing so, the inside of the external auditory meatus is disconnected from the outside thereof due to cap portion 855. The inside of the external auditory meatus, however, is in communication with the outside thereof due to the presence of holes 856. Thus, even in a state where a user wears the conventional earphone, external environmental sounds impinge on the inside of the external auditory meatus and reach the eardrum. Therefore, the insertion of ear pad 850 does not lead to a reduction in safety.

Nevertheless, in conventional earphones, cap portion 855, pressed and deformed by the external auditory meatus, is pressed against the outer periphery of guide tube portion 852 and thereby holes 856 are blocked, due to thin cap portion 855, when the tip portion of ear pad 850 is inserted into the external auditory meatus. Therefore, cap portion 855 blocks the communication between the inside and the outside of the external auditory meatus, by which external environmental sounds do not reach the eardrum. Further, after impinging on the external auditory meatus through sound guide hole 816 and guide hole portion 853, the sounds from the driver unit do not exit to the outside, which deteriorates sound clearness and generates muffled or unclear sounds, thereby reducing the sound quality.

### SUMMARY OF THE PRESENT APPLICATION

Therefore, the Present Application has been developed to solve the foregoing problems of conventional ear pads, by providing an ear pad, and an earphone having the ear pad, wherein a plurality of radially extending slit-shaped openings (when viewed from the tip side) are formed in a cap-shaped elastically deformable portion connected to the tip of a cylindrical body portion and wherein a plurality of axially extending grooves, in communication with the openings, are formed in the periphery of the body portion. Thereby, even in cases where a deformable portion is deformed when the ear pad is inserted into the external auditory meatus, the embodiments described herein maintain the communication between the inside and the outside of the external auditory meatus so as not to block environmental sounds, reproduce sharp low sounds and clear mid and high sounds (with the sounds favorably exiting to the outside), and provide a comfortable fit, as well as a high sound quality.

Accordingly, the Present Application provides an ear pad, made of a deformable material and mounted on a casing of an earphone, at least a tip portion of which is insertable into an ear. The ear pad comprises a cylindrical body portion in which a sound guide hole is formed to cause a sound, generated by the earphone, to impinge on the ear. A deformable portion is connected to a tip of the body portion and slantingly spreads from the tip toward a rear end of the body portion. The deformable portion has radially extending slit-shaped openings (when viewed from the tip side of the body portion). The body portion has axially extending grooves formed corresponding to the openings in the outer peripheral surface of the body portion. The openings overlap with the corresponding grooves when the deformable portion is deformed and pressed against the outer peripheral surface of the body portion.

Further, in another embodiment of the Present Application, there is provided an ear pad wherein the tips of the openings are in communication with the tip of the sound guide hole. In a still further embodiment of the Present Application, there is provided an ear pad wherein the tips of the openings are continued to the tips of the grooves, respectively.

Further, the Present Application provides an earphone having the above-referenced ear pad and comprising a casing, including a cylindrical auricle insertion portion, and a driver unit, for generating sounds disposed in the casing. The body portion of the ear pad is mounted on the auricle insertion portion. In another embodiment of the Present Application, there is provided an earphone wherein the casing includes a conical portion connected to a base end of the auricle insertion portion. The conical portion has axially extending grooves formed corresponding to the openings in the surface of the conical portion. The tips of the grooves are in communication with the rear ends of the grooves of the body portion of the ear pad.

According to the Present Application, an ear pad has a plurality of slit-shaped openings radially extending when viewed from the tip side in a cap-shaped elastically deformable portion connected to the tip of a cylindrical body portion and a plurality of grooves in communication with the openings and axially extending in the periphery of the body portion. Thereby, even in cases where the elastically deformable portion is deformed when the ear pad is inserted into the external auditory meatus, it is possible to maintain the communication between the inside and the outside of the external auditory meatus so as not to block environmental sounds, but to reproduce sharp low sounds and clear mid and high sounds (with the sounds favorably exiting to the outside), and to provide a comfortable fit, as well as improved sound quality.

### BRIEF DESCRIPTION OF THE FIGURES

The organization and manner of the structure and operation of the Present Application, together with further objects and advantages thereof, may best be understood by reference to the following Detailed Description, taken in connection with the accompanying Figures, wherein like reference numerals identify like elements, and in which:

FIG. 1 is a perspective view of an earphone according to the Present Application, as well as a partial cutaway view thereof;

FIG. 2 is a five-side view of the earphone of FIG. 1, wherein FIG. 2A is from the top;

FIG. 2B, the left side; FIG. 2C, the rear; FIG. 2D, the right side; and FIG. 2E, the front;

FIG. 3 is a cross-section of the earphone of FIG. 1, taken along Line A-A of FIG. 2C;

FIG. 4 is a four-side view of an ear pad according to the Present Application, wherein FIG. 4A is from the left side; FIG. 4B, the rear; FIG. 4C, the right side; and FIG. 4D, the front;

FIG. 5 is a cross-section of the ear pad of FIG. 4, wherein FIG. 5A is taken along Line B-B of FIG. 4B; FIG. 5B is taken along Line C-C of FIG. 4B; FIG. 5C is taken along Line D-D of FIG. 4C; and FIG. 5D is taken along Line E-E of FIG. 4C; and

FIG. 6 is a partial cross-sectional view of the structure of a conventional earphone.

### DESCRIPTION OF THE PREFERRED EMBODIMENTS

While the Present Application may be susceptible to embodiment in different forms, there is shown in the Figures, and will be described herein in detail, specific embodiments, with the understanding that the disclosure is to be considered an exemplification of the principles of the Present Application, and is not intended to limit the Present Application to that as illustrated.

In the illustrated embodiments, directional representations—i.e., up, down, left, right, front, rear and the like, used for explaining the structure and movement of the various elements of the Present Application, are relative. These representations are appropriate when the elements are in the position shown in the Figures. If the description of the position of the elements changes, however, it is assumed that these representations are to be changed accordingly.

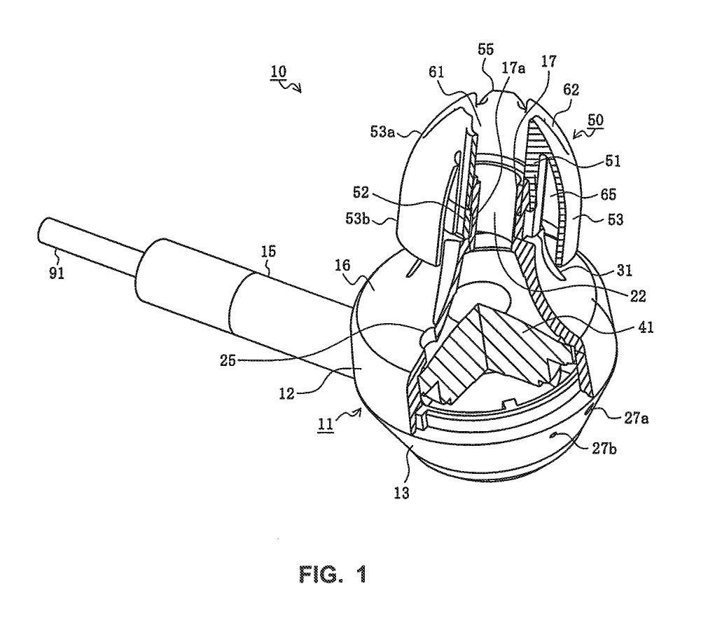

Referring to FIGS. 1-3, earphone 10, attached to the auricle of a user (i.e., the outer ear), is preferably a compact audio generator, driven by and reproducing an audio signal (as an electrical signal). Further, earphone 10 has casing or housing 11, which incorporates driver unit or speaker 41 for generating sounds by reproducing audio signals, and ear pad 50, which is mounted on casing 11 and at least the tip portion 55 of which is able to be inserted into the inner ear (external auditory meatus) of the user.

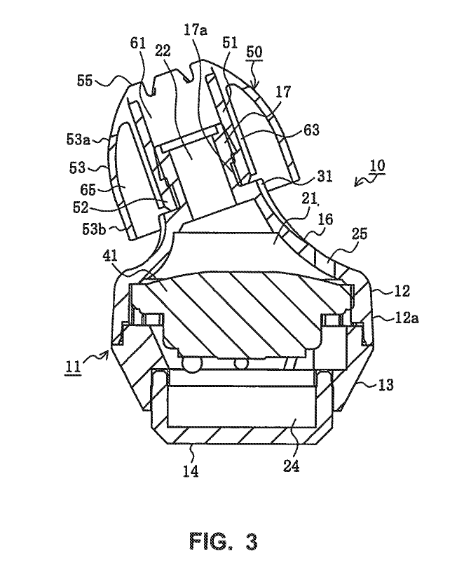

Casing 11 preferably includes front casing 12 located on the front side thereof, truncated cone-like rear casing 13 connected to the rear side of base 12a of front casing 12, and lid casing 14 connected to the rear side of rear casing 13. Further, as shown in FIG. 3, driver unit 41 may be held inside casing 11 with its front and rear (the upper and lower sides) interposed between front casing 12 and rear casing 13. Moreover, the rear surface of rear casing 13 may be closed by lid casing 14, forming rear space 24, which is a space having the shape of a combination of a truncated cone and a cylinder, in the rear (the lower side) of driver unit 41 in casing 11. The surface opposed to driver unit 41 in rear space 24 is an inner surface of lid casing 14 and is preferably a flat surface parallel to a diaphragm, not shown, of driver unit 41. Moreover, driver unit 41 is preferably a dynamic driver, generating sounds by vibrating the diaphragm.

Although lid casing 14 is preferably separated from rear casing 13 in the shown example, lid casing 14 may be formed integrally with rear casing 13. Further, although casing 11 is preferably made of, for example, resin such as synthetic resin, casing 11 may be made of either a metal such as aluminum, steel, copper or the like, or a composite material made up of resin, carbon, metal or the like.

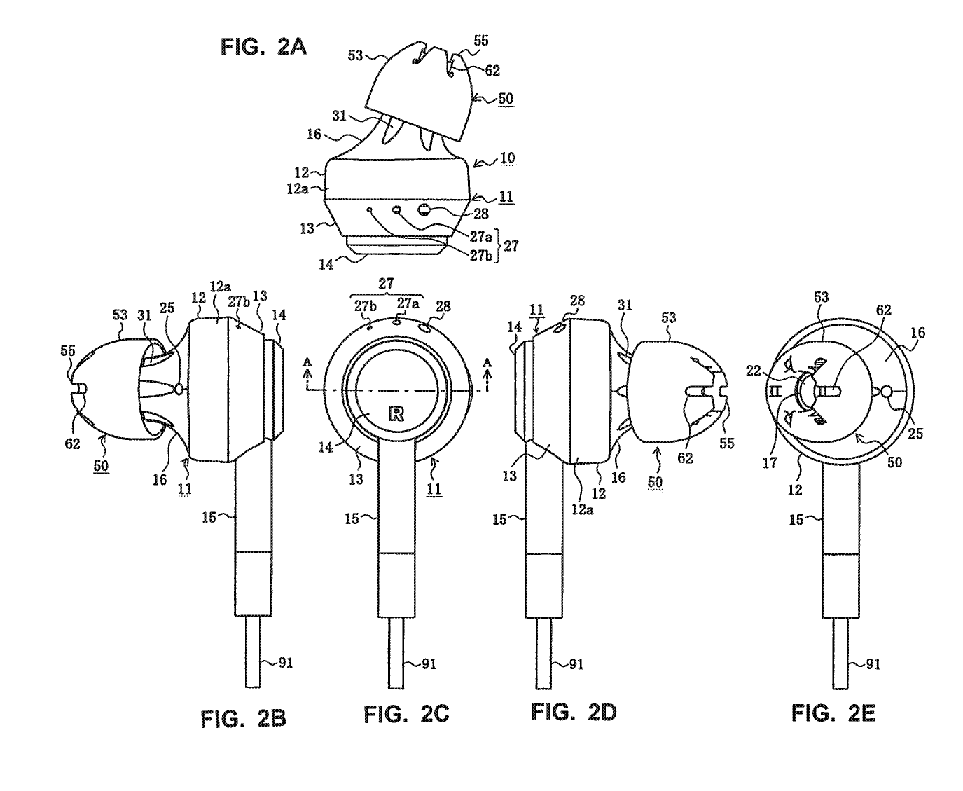

Further, lid casing 14 is preferably provided with an upper end, attached thereto, of cylindrical cable holding portion 15, which encloses and holds a part of electric wire cable 91, one end of which is connected to driver unit 41. Cable holding portion 15 may be formed integrally with lid casing 14. Further, electric wire cable 91 extends from the lower end of cable holding portion 15. In FIGS. 1-2, electric wire cable 91 is drawn only in a part adjacent to cable holding portion 15 and other parts are omitted for convenience of illustration. The other end, not shown, of electric wire cable 91 is connected to audio equipment, also not shown.

Front casing 12 preferably includes truncated conical portion 16, which projects forward from base 12a, and pad mounting portion 17 (acting as a cylindrical auricle insertion portion), which projects from the tip of conical portion 16, in addition to cylindrical base 12a. Conical portion 16 has a tip whose diameter is smaller than its base end (that portion connected to base 12a), thereby forming front space 21, which is a truncated cone-like space, in front of (i.e., upper side in FIG. 3) driver unit 41 in casing 11. Further, in pad mounting portion 17, there is formed casing sound guide hole 22, a cylindrical opening whose rear end is in communication with front space 21 and whose front end is open. Thereby, sounds generated by driver unit 41 impinge on the external auditory meatus of a user through front space 21 and casing sound guide hole 22. Although conical portion 16 is formed such that the central axis of its tip is inclined rightward with respect to the central axis of the base end in the shown example, the central axis of the tip may be inclined in any (or no) direction with respect to the central axis of the base end.

Moreover, front air duct 25 is formed in conical portion 16 of front casing 12. Front air duct 25 is preferably an air vent, or hole, having a circular cross section, formed so as to pass through conical portion 16, and communicating front space 21 with the outside to enable the air in front space 21 to vent to the outside. Front air duct 25 is formed in a portion near base 12a in conical portion 16; that is, a surface portion which faces forward. In other words, front air duct 25 is formed to face forward to enable the air in front space 21 to be vented forward. Although the diameter of front air duct 25 may be, for example, 1.2 mm, the diameter may be changed according to the performance of driver unit 41, the size of front space 21 or other factors.

Moreover, rear air duct 28, and first control hole 27a and second control hole 27b (i.e., tone control holes) are formed in rear casing 13. In cases where first control hole 27a and second control hole 27b are collectively described, these holes shall be referred to as control hole 27.

Rear air duct 28 is preferably a hole having a circular cross section, formed so as to pass through rear casing 13, and communicating rear space 24 with the outside to enable the air in rear space 24 to vent to the outside. Rear air duct 28 is formed in a surface portion which faces laterally in rear casing 13. In other words, rear air duct 28 is formed to face laterally to enable the air in rear space 24 to vent laterally. Although the diameter of rear air duct 28 is preset so as to be equal to front air duct 25, the diameter may be changed according to the performance of driver unit 41, the size of rear space 24 or other factors. The air vents having the same diameter, namely, front air duct 25 and rear air duct 28, are disposed in front space 21 and rear space 24, respectively, as described above, whereby it is possible to correct sound distortion and echo and to reduce a load on the diaphragm of driver unit 41.

Moreover, control holes 27 each have a circular cross section formed so as to pass through rear casing 13 and serve to communicate rear space 24 with the outside. In addition, control holes 27 are adjacent to rear air duct 28 and disposed in line on the same circumference in rear casing 13. Further, control holes 27 are formed so that the diameter of first control hole 27a is smaller than the diameter of rear air duct 28, and the diameter of second control hole 27b is smaller than first control hole 27a.

The diameter of first control hole 27a is preferably, for example, 0.8 mm. With the setting of the diameter of first control hole 27a to this value, it is possible to control the sounds in a frequency band around 1200 Hz, to provide smoother frequency responses, and to improve the sound quality. Further, the diameter of second control hole 27b is preferably, for example, 0.4 mm. With the setting of the diameter of second control hole 27b to this value, it is possible to control the sounds in a frequency band around 200 Hz, to provide smoother frequency responses, and to improve the sound quality.

Although there are provided two control holes 27, the number of control holes 27 may vary. Moreover, the diameter of control hole 27s may be changed according to the frequency band of the sounds to be controlled. More specifically, to control the sounds in a low frequency band, the diameter of control holes 27 may be decreased. Conversely, to control the sounds in a high frequency band, the diameter of control hole 27 may be increased.

Further, ear pad 50 is preferably mounted on pad mounting portion 17. Ear pad 50 is preferably made of a soft elastically deformable material such as, for example, silicon rubber, and may be an integrally formed member having cylindrical body portion 51 fit around pad mounting portion 17 and elastically deformable cap portion 53 slantingly spreading from the tip of body portion 51 toward the rear end thereof. At the rear end of body portion 51, there is formed thick flange-like engaging convex portion 52 projecting inward. Engaging convex portion 52 engages with grooved engaging concave portion 17a, formed in the base end portion of pad mounting portion 17 (a connecting portion to the tip of conical portion 16), to prevent ear pad 50 from being detached from pad mounting portion 17. Generally, ear pad 50 has a mushroom- or umbrella-like shape as a whole. At tip portion 55 of ear pad 50, the tip of body portion 51 is connected to the tip of cap portion 53 and cavity portion 65 is formed between the outer peripheral surface of body portion 51 and the inner peripheral surface of cap portion 53. Further, pad sound guide hole 61, a cylindrical opening with its front and rear ends open, is formed in the center of body portion 51. Pad sound guide hole 61 is in communication with casing sound guide hole 22 with ear pad 50 mounted on pad mounting portion 17.

Moreover, cap portion 53 includes truncated cone-like front half portion 53a, which spreads rearward, and cylindrical rear half portion 53b, which extends in the rear direction from the rear end of front half portion 53a. Cap portion 53 is flexible and thinner than body portion 51. Therefore, cap portion 53 can be easily deformed. Accordingly, when ear pad 50 is inserted into the external auditory meatus, cap portion 53 is elastically deformed so as to fit the inner surface shape of the external auditory meatus without damage thereto. Further, cap portion 53 comes in close contact with the inner surface of the external auditory meatus without applying a reaction force to the inner surface, thereby providing a comfortable fit.

Further, radially extending slit-shaped openings 62 are formed in front half portion 53a of cap portion 53 when viewed from the tip side. When a user wears earphone 10, ear pad 50 is inserted into the external auditory meatus, and cap portion 53 blocks the communication between the inside and the outside of the external auditory meatus. The inside of the external auditory meatus, however, is in communication with the outside thereof due to the presence of openings 62. Therefore, even when wearing earphone 10, external environmental sounds such as an alarm can impinge on the inside of the external auditory meatus and reach the eardrum, so that safety is not reduced. Moreover, the air in the external auditory meatus vents to the outside through openings 62, thereby reducing the sense of pressure, muffled quality and the like of the sounds which impinged on the inside of the external auditory meatus passing through casing sound guide hole 22 and pad sound guide hole 61 from driver unit 41. This improves the sharpness of low sounds and provides clear mid and high sounds. Further, the sounds from driver unit 41 do not press the eardrum; therefore, earphone 10 possesses no adverse health effects.

In the outer peripheral surface of body portion 51, pad grooves 63 extend in the fore- and aft- (i.e., axial) directions of body portion 51 in the places corresponding to openings 62, respectively. Therefore, even in cases where cap portion 53 is deformed and pressed against the outer peripheral surface of body portion 51 when ear pad 50 is inserted into the external auditory meatus, openings 62 overlap with pad grooves 63 corresponding thereto, thereby maintaining communication between the inside and the outside of the external auditory meatus.

Further, at least in the vicinity of the connecting portion of pad mounting portion 17 on the surface of conical portion 16 of front casing 12, casing grooves 31 extends in the fore- and aft- (i.e., axial) directions of conical portion 16 in the places corresponding to pad grooves 63, respectively. Moreover, the tips of casing grooves 31 are in communication with the rear ends of pad grooves 63, respectively, and extend more rearward than the rear end of cap portion 53. Therefore, even in cases where cap portion 53 is deformed and pressed against not only the outer peripheral surface of body portion 51, but the surface of conical portion 16 when ear pad 50 is inserted into the external auditory meatus, openings 62 are in communication with pad grooves 63 and casing grooves 31 corresponding to openings 62, thereby maintaining the communication between the inside and the outside of the external auditory meatus.

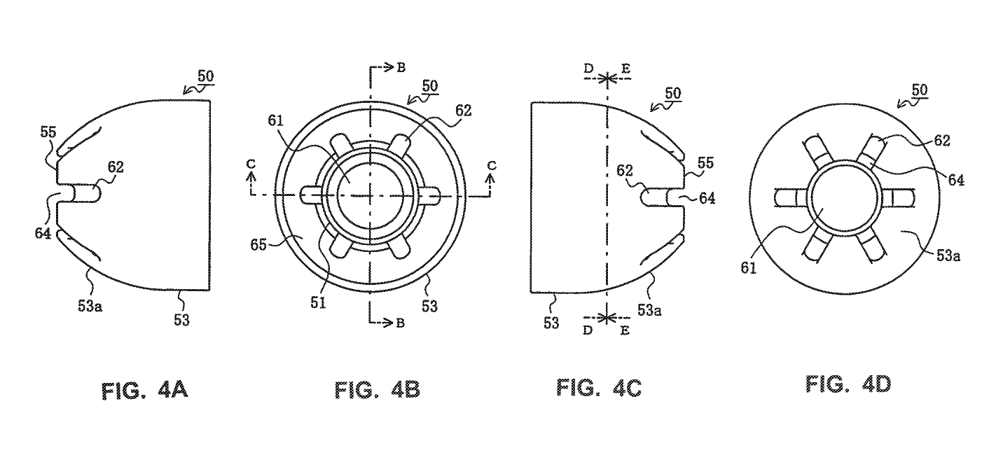

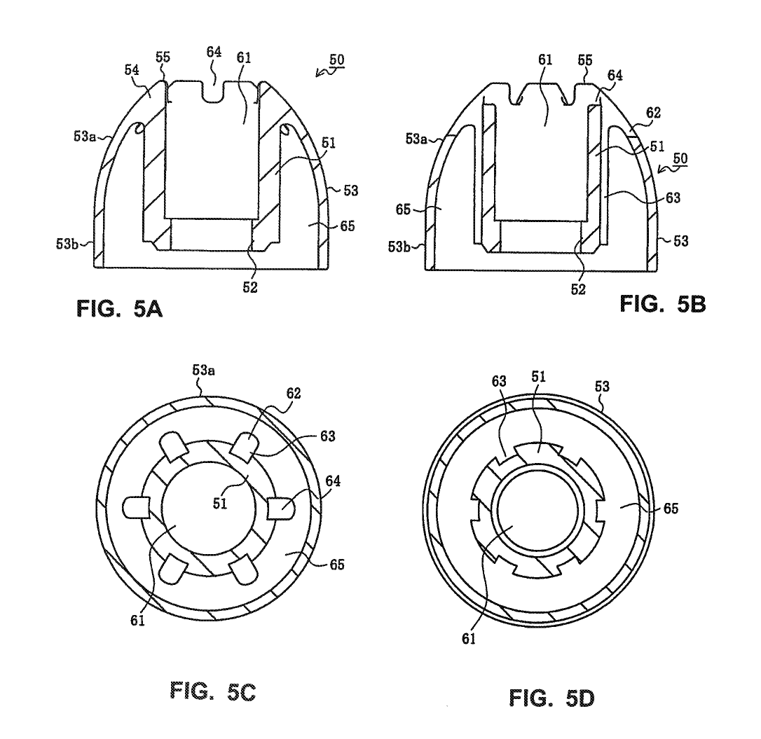

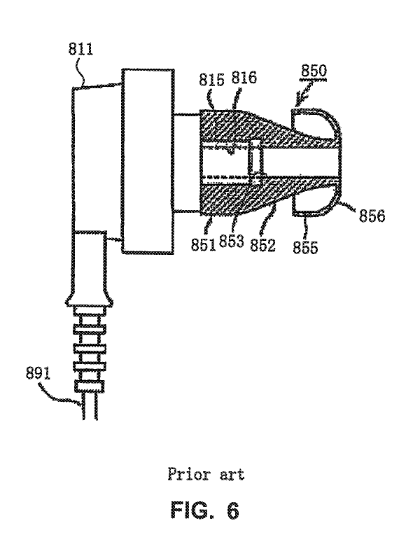

Referring to FIGS. 4-5, illustrating the configuration of ear pad 50, the tip of body portion 51 is connected to the tip of cap portion 53 via tip connecting portion 54, and the tip of openings 62 is in communication with the tip of pad sound guide hole 61 via communication recess 64. Further, in circular tip portion 55 of ear pad 50, tip connecting portions 54 and communication recesses 64 are disposed alternately. Accordingly, sounds, which impinge on the inside of the external auditory meatus passing through casing sound guide hole 22 and pad sound guide hole 61 from driver unit 41, partially exit from openings 62 to the outside via communication recesses 64. Therefore, pressure, muffled quality and other aspects are reduced, clarifying the sound.

Tip connecting portion 54 is preferably thicker than cap portion 53, shown in FIG. 5A, and therefore has higher rigidity and is undeformable. Moreover, communication recesses 64, each disposed between tip connecting portions 54, are formed so as to be recessed rearward from the tip edge of tip portion 55 (i.e., the tip edge of the tip connecting portion 54), viewed from the side surface. Accordingly, even in cases where cap portion 53 is deformed when ear pad 50 is inserted into the external auditory meatus, communication recess 64 is not blocked, but the communication between pad sound guide hole 61 and openings 62 is maintained. As described above, even in cases where cap portion 53 is deformed and pressed against not only the outer peripheral surface of body portion 51, the surface of conical portion 16, openings 62, pad grooves 63 and casing grooves 31 are in communication with each other. Therefore, sound passage is stably secured from pad sound guide hole 61 through communication recesses 64, openings 62, pad grooves 63 and casing grooves 31 to the outside, whereby pressure, muffled quality and other aspects are stably reduced, clarifying the sound.

Moreover, as shown in FIG. 5B, the tips of the openings 62 are preferably formed so as to be continued to the tips of the pad grooves 63, respectively. In this instance, even in cases where the cap portion 53 is significantly deformed, the communication between the openings 62 and the pad grooves 63 is stably maintained.

Further, in front half portion 53a of cap portion 53, slit-shaped openings 62 radially extend, when viewed from the front, are formed as shown in FIG. 4D. Accordingly, the rigidity of front half portion 53a is reduced and deformable due to the presence of openings 62. Therefore, when ear pad 50 is inserted into the external auditory meatus, not only front half portion 53a, but entire cap portion 53 is flexibly and elastically deformed so as to fit to the inner surface shape of the external auditory meatus. Thus, the Present Application does not damage the external auditory meatus. Further, cap portion 53 comes in close contact with the inner surface of the external auditory meatus without applying a reaction force thereto, thereby providing a comfortable fit. In the example, the number of openings 62, of pad grooves 63, of casing grooves 31 and of communication recesses 64 is six. This number, of course, may vary.

Thus, in FIGS. 4-5, ear pad 50 includes cylindrical body portion 51, by which pad sound guide hole 61 causes sounds generated by earphone 10 to impinge on the external auditory meatus, and cap portion 53, connected to the tip of body portion 51 and slantingly spread from the tip of body portion 51 toward the rear end thereof. Further, cap portion 53 includes radially extending slit-shaped openings 62, and body portion 51 includes axially extending pad grooves 63, formed in the places respectively corresponding to openings 62 in the outer peripheral surface of body portion 51, so that openings 62 overlap with corresponding pad grooves 63 when cap portion 53 is deformed and pressed against the outer peripheral surface of body portion 51.

Thus, the communication between the inside and the outside of the external auditory meatus is maintained even in cases where cap portion 53 is deformed and pressed against the outer peripheral surface of body portion 51 when ear pad 50 is inserted into the external auditory meatus. Accordingly, external environmental sounds impinge on the inside of the external auditory meatus and reach the eardrum. Moreover, the air in the external auditory meatus vents to the outside through openings 62, thereby reducing the pressure, muffled quality and other aspects which impinge on the inside of the external auditory meatus from earphone 10. This improves the sharpness of low sounds and provides clear mid and high sounds. Further, sounds from earphone 10 do not press the eardrum; therefore, earphone 10 has no adverse health effects.

Moreover, the tips of openings 62 are in communication with the tip of pad sound guide hole 61. Thereby, the sounds, which impinge on the inside of the external auditory meatus passing through pad sound guide hole 61, partially exit openings 62 to the outside via communication recesses 64, which reduces pressure, muffled quality and other aspects, thereby clarifying the sound. Further, the tips of openings 62 continue to the tips of pad grooves 63, respectively. Thus, even in cases where cap portion 53 is significantly deformed, the communication between openings 62 and pad grooves 63 is stably maintained.

Further, earphone 10 includes casing 11, which includes cylindrical pad mounting portion 17 and driver unit 41, disposed inside casing 11 for generating sounds. Additionally, body portion 51 of ear pad 50 is mounted on pad mounting portion 17. Thereby, even in cases where cap portion 53 is deformed and pressed against the outer peripheral surface of body portion 51 when ear pad 50 is inserted into the external auditory meatus, the communication between the inside and the outside of the external auditory meatus is maintained. Therefore, the Present Application is capable of preventing external environmental sounds from being blocked, reproducing sharp low sounds and clear mid and high sounds with the sounds favorably exiting to the outside, and providing both a more comfortable fit and an improved sound quality.

Moreover, casing 11 includes conical portion 16 connected to the base end of pad mounting portion 17. Conical portion 16 includes axially extending casing grooves 31, which are formed in places corresponding to openings 62, respectively, on the surface of conical portion 16. Further, the tips of casing grooves 31 are in communication with the rear ends of pad grooves 63 provided in body portion 51 of ear pad 50. Thereby, even in cases where cap portion 53 is deformed and is pressed against not only the outer peripheral surface of body portion 51, but also the surface of conical portion 16, when ear pad 50 is inserted into the external auditory meatus, openings 62 are in communication with pad grooves 63 and casing grooves 31 corresponding to openings 62. Thus, the communication between the inside and the outside of the external auditory meatus is maintained.

While a preferred embodiment of the Present Application is shown and described, it is envisioned that those skilled in the art may devise various modifications without departing from the spirit and scope of the foregoing Description and the appended Claims.

What is claimed is:

1. An ear pad (50), made of an elastically deformable material and mounted on a casing (11) of an earphone (10), at least a tip portion (55) of which is insertable into an external auditory meatus, the ear pad (50) comprising:
a cylindrical body portion (51), the cylindrical body portion (51) having a sound guide hole (61) formed therein, the sound guide hole (61) adapted to cause a sound generated by the earphone (10) to impinge on the external auditory meatus; and
an elastically deformable portion (53), the elastically deformable portion (53) being connected to a tip of the body portion (51) and slantingly spread from the tip toward a rear end of the body portion (51);
wherein:
the elastically deformable portion (53) includes a plurality of slit-shaped openings (62), each slit-shaped opening (62) radially extending from the elastically deformable portion (53) when viewed from the tip side of the body portion (51);
the body portion (51) includes grooves (63), the grooves (63) axially extending from the body portion (51) and formed in places corresponding to the openings (62) in the outer peripheral surface of the body portion (51); and
each slit-shaped opening (62) overlaps with a corresponding one of the grooves (63) in cases where the elastically deformable portion (53) is deformed and pressed against the outer peripheral surface of the body portion (51).

2. The ear pad (50) of claim 1, wherein the tips of each slit-shaped opening (62) is in communication with the tip of the sound guide hole (61).

3. The ear pad (50) of claim 2, wherein the tips of each slit-shaped opening (62) continues to the tips of a corresponding one of the grooves (63).

4. The ear pad (50) of claim 3, wherein the earphone (10) further comprises:
a casing (11), the casing (11) including a cylindrical auricle insertion portion (17); and
a driver unit (41), the driver unit (41) adapted for generating sounds disposed in the casing (11).

5. The ear pad (50) of claim 4, wherein the body portion (51) of the ear pad (50) is mounted on the auricle insertion portion (17).

6. The ear pad (50) of claim 5, wherein the casing (11) includes a conical portion (16) connected to a base end of the auricle insertion portion (17), and the conical portion (16) has grooves (31) axially extending and formed in places respectively corresponding to each slit-shaped opening (62) in the surface of the conical portion (16).

7. The ear pad of claim 6, wherein the tips of the grooves (31) are in communication with the rear ends of the grooves (63) of the body portion (51) of the ear pad (50).

8. The ear pad (50) of claim 1, wherein the tips of each slit-shaped opening (62) continues to the tips of a corresponding one of the grooves (63).

9. The ear pad (50) of claim 8, wherein the earphone (10) further comprises:
a casing (11), the casing (11) including a cylindrical auricle insertion portion (17); and
a driver unit (41), the driver unit (41) adapted for generating sounds disposed in the casing (11).

10. The ear pad (50) of claim 9, wherein the body portion (51) of the ear pad (50) is mounted on the auricle insertion portion (17).

11. The ear pad (50) of claim 10, wherein the casing (11) includes a conical portion (16) connected to a base end of the auricle insertion portion (17), and the conical portion (16) has grooves (31) axially extending and formed in places respectively corresponding to each slit-shaped opening (62) in the surface of the conical portion (16).

12. The ear pad of claim 11, wherein the tips of the grooves (31) are in communication with the rear ends of the grooves (63) of the body portion (51) of the ear pad (50).

13. The ear pad (50) of claim 1, wherein the earphone (10) further comprises:
a casing (11), the casing (11) including a cylindrical auricle insertion portion (17); and
a driver unit (41), the driver unit (41) adapted for generating sounds disposed in the casing (11).

14. The ear pad (50) of claim 13, wherein the body portion (51) of the ear pad (50) is mounted on the auricle insertion portion (17).

15. The ear pad (50) of claim 14, wherein the casing (11) includes a conical portion (16) connected to a base end of the auricle insertion portion (17), and the conical portion (16) has grooves (31) axially extending and formed in places respectively corresponding to each slit-shaped opening (62) in the surface of the conical portion (16).

16. The ear pad of claim 15, wherein the tips of the grooves (31) are in communication with the rear ends of the grooves (63) of the body portion (51) of the ear pad (50).

17. The ear pad (50) of claim 2, wherein the earphone (10) further comprises:
a casing (11), the casing (11) including a cylindrical auricle insertion portion (17); and
a driver unit (41), the driver unit (41) adapted for generating sounds disposed in the casing (11).

18. The ear pad (50) of claim 17, wherein the body portion (51) of the ear pad (50) is mounted on the auricle insertion portion (17).

19. The ear pad (50) of claim 18, wherein the casing (11) includes a conical portion (16) connected to a base end of the auricle insertion portion (17), and the conical portion (16) has grooves (31) axially extending and formed in places respectively corresponding to each slit-shaped opening (62) in the surface of the conical portion (16).

20. The ear pad of claim 19, wherein the tips of the grooves (31) are in communication with the rear ends of the grooves (63) of the body portion (51) of the ear pad (50).
